(19) United States
(12) Patent Application Publication
(10) Pub. No.: US 2004/0254305 A1
(43) Pub. Date: Dec. 16, 2004

(54) Epoxy resin composition for photosemiconductor package

(76) Inventors: Kuen-Yuan Hwang, Hsinchu (TW); An-Pang Tu, Hsinchu (TW); Chih-Fu Chen, Hsinchu (TW)

Correspondence Address: WOMBLE CARLYLE SANDRIDGE & RICE, PLLC, P.O. BOX 7037, ATLANTA, GA, 30357-0037, US

(21) Appl. No.: 10/860,924

(22) Filed: Jun. 4, 2004

(30) Foreign Application Priority Data
Jun. 11, 2003 (TW) 092115791

(51) Int. Cl. C08G 59/02

(52) U.S. Cl. 525/407

(57) ABSTRACT

An epoxy resin composition containing (A) at least two kinds of epoxy resins, wherein the epoxy resin represented by Formula (I) is in an amount of 10 to 90% by weight based on the total amount of the epoxy resins, (B) a hardener and (C) a hardening accelerator is proposed:

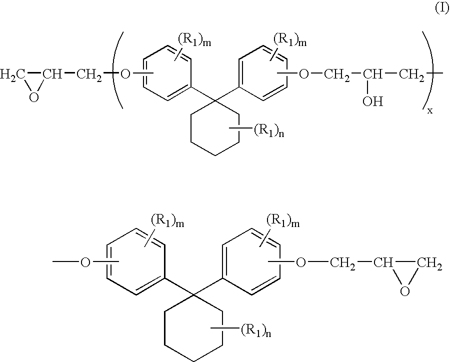

wherein each formula symbol is defined as in the above specification. The epoxy resin composition proposed in the present invention, which is characterized with excellent light transmittance and heat resistance and low moisture absorption, is particularly useful in packaging photosemiconductor elements.

### FIELD OF THE INVENTION

The present invention relates to an epoxy resin composition, and more particularly, to an epoxy resin composition which is used in fabricating semiconductor elements requiring high light transmittance.

### BACKGROUND OF THE INVENTION

An epoxy resin which is characterized with easy processing, high safety and excellent mechanical and chemical properties has been widely applied in many fields such as coating, electrical insulation, construction building materials, adhesives and laminates. Additionally, the epoxy resin also serves as plastic packaging materials for photosemiconductor elements such as light receiving elements and light emitting elements, including light emitting diodes, photocouplers, receivers, etc.

Plastic packages can be sealed with the resin by fabrication methods such as transfer molding, radial-spray coating and reaction-injection molding. Among these, the transfer molding method has provided advantages such as a high production rate, low raw material consumption, low equipment maintaining costs, no flash generated on the edge of products and selectable coating options. Thus, the transfer molding method is highly economically effective, which is often employed in fabricating miniaturized products with high dimension stability.

In a later stage for fabrication of plastic packages using surface mount technology (SMT), semiconductor elements need to be directly immersed in a solder tank under a temperature of 230° C. or higher. The presently used epoxy resin composition which mainly includes bisphenol A glycidyl ether, an acid anhydride as a hardener and a hardening accelerator provides good light transmittance and achieves the criteria of heat resistance and moisture absorption. However, in reference to the plastic packages fabricated by surface mount technology, the presently used epoxy resin composition cannot achieve the criteria of the moisture absorption and the heat resistance while simultaneously maintaining the high light transmittance. Therefore, cracking and de-layering easily occur in the interface between the packaging materials of fabricated products and die pads, so as to result in the so-called ‘popcorn phenomenon’ to thereby adversely affecting the quality of the products.

Along with the development of miniaturized semiconductor elements, a reinforced adhesive interface between the packaging material and the die pad as well as reduction of the moisture absorption of the packaging material are important key factors to improve the quality of the products. What is needed, therefore, is to provide an epoxy resin composition characterized with good heat resistance and low moisture absorption while maintaining the high light transmittance.

### SUMMARY OF THE INVENTION

The primary objective of the present invention is to provide an epoxy resin composition having excellent light transmittance as well as good reflow heat resistance and low moisture absorption.

In accordance with the above and other objectives, the present invention proposes an epoxy resin composition which comprises (A) at least two kinds of epoxy resins, wherein the epoxy resin represented by Formula (I) is an amount of 10 to 90% by weight based on the total amount of the epoxy resins; (B) a hardener; and (C) a hardening accelerator:

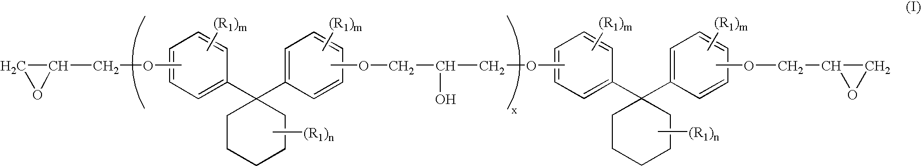

wherein R₁ is a group independently selected from the group consisting of C₁₋₈ alkyls, C₁₋₈ alkoxys, C₃₋₈ cycloalkyls and halogens; m is an integer from 0 to 4; n is an integer from 0 to 5; and x is a number from 0 to 6.

In the structure represented by the above Formula (I), the C₁₋₈ alkyl represented by R₁ is a linear or branched alkyl having 1 to 8 carbon atoms. Examples of the C₁₋₈ alkyls include, but are not limited to, methyl, ethyl, n-propyl, isopropyl, n-butyl, isobutyl, s-butyl, t-butyl, amyl, 2-amyl, 3-amyl, 2-methyl-1-butyl, isoamyl, s-amyl, 3-methyl-2-buty, neo-amyl, hexyl, 4-methyl-2-amyl, heptyl, octyl and the like. The C₁₋₈ alkoxy is a linear or branched alkoxy having 1 to 8 carbon atoms. Examples of the C₁₋₈ alkoxys include, but are not limited to, methoxy, ethoxy, propoxy, isopropoxy, butoxy, isobutoxy, s-butoxy, t-butoxy, amoxy, isoamoxy, neo-amoxy, hexoxy, octoxy, and the like. The C₃₋₈ cycloalkyl is a cyclic alkyl having 3 to 8 carbon atoms. Examples of the C₃₋₈ cycloalkyls include, but are not limited to, cyclopropyl, cyclobutyl, cyclopentyl, cyclohexyl, and the like. Examples of halogens include fluorine, chlorine, bromine and iodine.

Referring to the epoxy resin composition proposed in the present invention, the epoxy resin represented by Formula (I) is an amount of 10 to 90% by weight based on the total amount of the epoxy resins. Therefore, the epoxy resin composition is characterized with the excellent light transmittance as well as the good reflow heat resistance and the low moisture absorption.

### DETAILED DESCRIPTION OF THE EMBODIMENTS

Referring to the epoxy resin composition of the present invention, cyclohexanone is condensed with a phenol compound in the presence of an acidic catalyst to produce bisphenol compounds represented by the following Formula (II), such that the bisphenol compound is then epoxidized to produce the epoxy resin represented by the foregoing Formula (I).

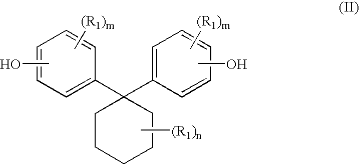

wherein R₁, m and n are defined as the above.

Examples of the phenol compounds for condensation can be substituted or unsubstituted phenol compounds, which include, but are not limited to, phenol, o-cresol, p-cresol, m-cresol, ethylphenol, propylphenol, isopropylphenol, butylphenol, s-butylphenol, t-butylphenol, amylphenol, isoamylphenol, cyclopentylphenol, hexylphenol, cyclohexylphenol, octylphenol, nonylphenol, xylenol, methylbutylphenol, methoxyphenol, chlorophenol, bromophenol, dichlorophenol, dibromophenol, 2,5-difluoro-4-cresol, 2,5-dibromo-4-cresol, 4-isopropyl-2-methoxyphenol, 4-isopropyl-3-methoxyphenol, 2-chloro-4-isopropylphenol, 3-chloro-4-isopropylphenol, 2,5-difluoro-4-isopropylphenol, 2,5-dichloro-4-isopropylphenol, 2,5-dibromo-4-isopropylphenol, and the like. These phenol compounds can be used singly or in combination as a mixture containing two or more different phenol compounds. The flame retardancy of the obtained products can be improved by using the phenol compounds substituted with the halogens.

Examples of cyclohexanones include substituted or unsubstituted cyclohexanones. Examples of substituents include a linear or branched alkyl having 1 to 8 carbon atoms, a linear or branched alkoxy having 1 to 8 carbon atoms, a cyclic alky having 3 to 8 carbon atoms, halogens, and the like.

Examples of the acidic catalysts used in the condensation for forming the bisphenol compounds represented by Formula (II) include, but are not limited to, organic acids such as acetic acids and toluene sulfonic acids, inorganic acids such as hydrochloric acid and sulfuric acids and other Lewis acids, or the like. Additionally, sulfides such as mercaptans and ethylmercaptans can be used as assistant catalysts to promote reactions.

The condensation can be conducted using conventional methods, in which the amount of the phenol compound depends on the moles of the consumed cyclohexanone. It is preferred that the amount of the phenol compound is two or more times than the moles of the cyclohexanone. After the condensation, the mixture is rinsed with water and filtered to remove any unreacted phenol compound. Then, the resulting solution is optionally recrystallized to remove the remaining phenol compound to obtain the bisphenol compound represented by Formula (II). The obtained bisphenol compound may contain a trace amount of the phenol compound, provided that such trace amount of the remaining phenol compound does not significantly influence the effects of the present invention.

Subsequently, the epoxy resin represented by Formula (I) is prepared by epoxidizing the obtained bisphenol compound and epichlorohydrin in the presence of sodium hydroxide or other suitable catalysts (for example, lithium compounds such as lithium hydroxide, lithium chloride and lithium acetate; and quaternary ammonium salts such as tetramethylammonium chloride and benzyltrimethylammonium chloride). Those skilled in the art can optionally adjust the ratio of the bisphenol compound to epichlorohydrin and operating conditions for the epoxidation to produce different kinds of epoxy resins, such as liquid epoxy resins, solid epoxy resins of low molecular weights, solid epoxy resins of high molecular weights, etc.

The suitable solvents for producing the epoxy resins represented by Formula (I) can be chosen depending on reaction systems to be used according to the experience of those skilled in the art. Examples of these solvents include, but are not limited to, alcohol solvents such as methanol, ethanol, propanol, isopropanol, ethandiol, and the like; ether solvents such as 1,2-dimethoxyethane, tetrahydrofuran, dioxane, and the like; ketone solvents such as acetone, methyl ethyl ketone, methyl isopropyl ketone, and the like; ester solvents such as methyl acetate, ethyl acetate, and the like; and hydrocarbon solvents such as toluene, xylene, and the like.

Referring to the component (A) of the epoxy resin composition proposed in the present invention, yields of the products are easily reduced due to poor heat resistance if the epoxy resin represented by Formula (I) is in an amount of less than 10% by weight based on the total amount of the epoxy resins. A light transmittance (T) of 85% cannot be achieved if the epoxy resin represented by Formula (I) is in an amount of more than 90% be weight based on the total amount of the epoxy resins. Therefore, the epoxy resin represented by Formula (I) is in an amount of 10 to 90%, preferably 15 to 85%, and more preferably 20 to 80% by weight based on the total amount of epoxy resins in component (A) of the epoxy resin composition proposed in the present invention.

Apart from including the epoxy resin represented by Formula (I) in an amount of 10 to 90% by weight based on the total amount of the epoxy resins, the epoxy resins in the component (A) of the epoxy resin composition proposed in the present invention also includes bifunctional epoxy resins containing two or more epoxy groups per molecule. The epoxy groups in the bifunctional epoxy resins can be formed by oxidation of olefins, glycidyl group etherification of hydroxyl groups, glycidyl group amination of primary and secondary amines or glycidyl group esterification of carboxylic acids.

Glycidyl ethers are preferably used as the bifunctional epoxy resins in the component (A) of the epoxy resin composition proposed in the present invention. Examples of monomers for the epoxy resins include but are not limited to, bisphenol glycidyl ether, biphenyol glycidyl ether, benzenediol glycidyl ether, nitrogen-containing hetero-ring glycidyl ether, dihydroxynaphthalene glycidyl ether, phenolic polyglycidyl ether, polyhydric phenol polyglycidyl ether, and the like.

Examples of bisphenol glycidyl ethers include, but are not limited to, bisphenol A glycidyl ether, bisphenol F glycidyl ether, bisphenol AD glycidyl ether, bisphenol S glycidyl ether, tetramethylbisphenol A glycidyl ether, tetramethylbisphenol F glycidyl ether, tetramethylbisphenol AD glycidyl ether, tetramethylbisphenol S glycidyl ether, bisphenol glycidyl ether substituted with the halogens (such as tetrabromobisphenol A glycidyl ether), and the like.

Examples of biphenol glycidyl ethers include, but are not limited to, 4,4′-biphenol glycidyl ether, 3,3′-dimethyl-4,4′-biphenol glycidyl ether, 3,3′,5,5′-tetramethyl-4,4′-biphenol glycidyl ether, and the like.

Examples of benzenediol glycidyl ethers include, but are not limited to, resorcinol glycidyl ether, hydroquinone glycidyl ether, isobutylhydroquinone glycidyl ether, and the like.

Examples of nitrogen-containing hetero-ring glycidyl ethers include, but are not limited to, triglycidyl ether of isocyanurate, triglycidyl ether of cyanurate, and the like.

Examples of dihydroxynaphthalene glycidyl ethers include, but are not limited to, 1,6-dihydroxynaphthalenediglycidyl ether, 2,6-dihydroxynaphthalenediglycidyl ether, and the like.

Examples of phenol-aldehyde polyglycidyl ethers include, but are not limited to, phenol-formaldehyde polyglycidyl ether, cresol-formaldehyde polyglycidyl ether, bisphenol A-formaldehyde polyglycidyl ether, and the like.

Examples of phenylpolyhydric phenol polyglycidyl ethers include, but are not limited to, tris(4-hydroxyphenyl)methane polyglycidyl ether, tris(4-hydroxyphenyl)ethane polyglycidyl ether, tris(4-hydroxyphenyl)propane polyglycidyl ether, tris(4-hydroxyphenyl)butane polyglycidyl ether, tris(3-methyl-4-hydroxyphenyl)methane polyglycidyl ether, tris(3,5-dimethyl-4-hydroxyphenyl)methane polyglycidyl ether, tetrakis(4-hydroxyphenyl)ethane polyglycidyl ether, tetrakis(3,5-dimethyl-4-hydroxyphenyl)ethane polyglycidyl ether, dicyclopentene-phenolic polyglycidyl ether, and the like.

These bifunctional epoxy resins can be used singly or in combination as a mixture containing two or more different bifunctional epoxy resins. Bisphenol A glycidyl ethers, bisphenol F glycidyl ethers, phenol-aldehyde polyglycidyl ethers, triglycidyl ethers of isocyanurate or mixtures thereof are preferred in the means of better light transmittance and heat resistance of the products.

Examples of the hardeners of the component (B) in the epoxy resin composition proposed in the present invention include, but are not limited to, amine compounds, polycarboxylic acids or anhydride thereof compounds, benzenediol compounds, bisphenol resins, biphenol compounds, polyhydric phenol resins, phenol-aldehyde condensates, and the like.

Examples of the amine compounds include, but are not limited to, aliphatic amine compounds, such as diethylene triamine (DETA), triethylene tetramine (TETA), tetraethylene pentamine (TEPA), diethylaminopropylamine (DEAPA), methylene diamine, N-aminoethylpyrazine (AEP), m-xylylene diamine (MXDA), methylene bis(aminocyclohexane), and the like; aromatic amine compounds such as m-phenylene diamine (MPDA), diaminodiphenylmethane (MDA), diaminodiphenylsulfone (DADPS), diamino diphenyl ether, tolylene diamine, biphenyl amine, methylenebis(chloroaniline), and the like; and secondary or tertiary amine compounds such as phenylmethyldimethylamine (BDMA), dimethylaminomethylphenol (DMP-10), tris(dimethylaminomethyl)phenol (DMP-30), piperidine, tetramethylguanidine, and the like.

Examples of the polycarboxylic acids or anhydride thereof compounds include, but are not limited to, maleic anhydride (MA), phthalic anhydride (PA), hexahydro-o-phthalic anhydride (HHPA), tetrahydrophthalic anhydride (THPA), pyromellitic dianhydride (PMDA) and trimellictic anhydride (TMA), and methyltetrahydrophthalic anhydride, and the like.

Examples of the benzenediol compounds include, but are not limited to, resorcinol, hydroquinone, and isobutylhydroquinone.

Examples of the bisphenol resins include those represented by the formula HO—Ph—X—Ph—OH (wherein Ph represents phenyl; and X represents —C(CH₃)₂—, —O—, —S—, —CO— or —SO₂—) including bisphenol A, bisphenol F, bisphenol AD, bisphenol S, tetramethylbisphenol A, tetramethylbisphenol F, tetramethylbisphenol AD and tetramethylbisphenol S.

Examples of the biphenol compounds include, but are not limited to, 4,4′-biphenol, 3,3′-dimethyl-4,4′-biphenol, 3,3′,5,5′-tetramethyl-4,4′-biphenol, and the like.

Examples of the polyhydric phenol resins include, but are not limited to, tris(4-hydroxyphenyl)methane, tris(4-hydroxyphenyl)ethane, tris(4-hydroxyphenyl)propane, tris(4-hydroxyphenyl)butane, tris(3-methyl-4-hydroxyphenyl)methane, tris(3,5-dimethyl-4-hydroxyphenyl)methane, tetrakis(4-hydroxyphenyl)ethane and tetrakis(3,5-dimethyl-4-hydroxyphenyl)ethane, and the like.

Examples of the phenol-aldehyde condensates include, but are not limited to, phenol-formaldehyde condensates, cresol-formaldehyde condensates, bisphenol A phenolic condensates, bicyclopentdiene-phenolic condensates, and the like.

Examples of other hardeners used for the epoxy resins include, but are not limited to, urea resins, melamine resins, polyamide resins, dicyanodiamide, boron fluoride-amine complexes, and the like.

The hardeners of the component (B) in the epoxy resin composition proposed in the present invention can be used singly or in combination as a mixture containing two or more different hardeners. The hardener is added in an amount based on the active hydrogen equivalent weight in the hardener, in which the amount of the hardener to be added is 0.7 to 1.3 times of the epoxy equivalent weight in the epoxy resins of the component (A). The excellent moisture absorption cannot be achieved if the addition amount of the hardener is 0.7 times less or 1.3 times more than the epoxy equivalent weight. Additionally, the hardeners can be added in an amount of 5 to 50%, and more preferably 20 to 50%, by weight based on the total weight of the composition.

The hardening accelerators of the component (C) in the epoxy resin composition proposed in the present invention include, but are not limited to, tertiary amines, tertiary phosphines, quaternary ammonium salts, quaternary phosphonium salts, born trifluoride complex salts, lithium-containing compounds, imidazole compounds, or mixtures thereof.

Examples of the tertiary amines include, but are not limited to, triethylamine, tributylamine, triamylamine, dimethylaminoethanol, dimethylaniline, diethylaniline, α-methylbenzyldimethylamine, N,N-dimethyl-aminocresol, tr(N,N-dimethyl-aminomethyl)phenol, 1,8-diazabicyclo[5,5,0]undec-7ene, and the like.

Examples of the tertiary phosphines include, but are not limited to, triphenylphosphine, tributylphosphine, trioctylphosphine, tri(4-methylphenyl)phosphine, tri(4-methoxyphenyl)phosphine, tri(2-cyanoethyl)phosphine, and the like.

Examples of the quaternary ammonium salts include, but are not limited to, tetramethylammonium chloride, tetramethylammonium bromide, tetramethylammonium iodide, tetraethylammonium chloride, tetraethylammonium bromide, tetraethylammonium iodide, tetrabutylammonium chloride, tetrabutylammonium bromide, tetrabutylammonium iodide, triethylbenzylammonium chloride, triethylbenzylammonium bromide, triethylbenzylammonium iodide, triethylphenylethylammonium chloride, triethylphenylethylammonium bromide, triethylphenylethylammonium iodide, and the like.

Examples of the quaternary phosphonium salts include, but are not limited to, tetrabutylphophonium chloride, tetrabutylphosphonium bromide, tetrabutylphophonium iodide, tetrabutylphosphonium acetate, tetraphenylphosphonium chloride, tetraphenylphosphonium bromide, tetraphenylphosphonium iodide, ethyltriphenylphosphonium chloride, ethyltriphenylphosphonium bromide, ethyltriphenylphosphonium iodide, ethyltriphenylphosphonium acetate, ethyltriphenylphosphonium phosphate, propyltriphenylphosphonium chloride, propyltriphenylphosphonium bromide, propyltriphenylphosphonium iodide, butyltriphenylphosphonium chloride, butyltriphenylphosphonium bromide, butyltriphenylphosphonium iodide, and the like.

Examples of the imidazole compounds include, but are not limited to, 2-methylimidazole, 2-ethylimidazole, 2-laurylimidazole, 2-heptadecylimidazole, 2-phenylimidazole, 4-methylimidazole, 4-ethylimidazole, 4-laurylimidazole, 4-heptadecylimidazole, 2-phenyl-4-methylimidazole, 2-phenyl-4-hydroxymethylimidazole, 2-ethyl-4-methylimidazole, 2-ethyl-4hydroxymethylimidazole, 1-cyanoethyl-4-methylimidazole, 2-phenyl-4,5-dihydroxymethylimidazole, and the like.

These hardening accelerators can be used singly or in combination as a mixture containing two or more different hardening accelerators. Among them, the preferred hardening accelerators are the imidazole compounds and the quaternary phosphonium salts, and more specifically, 2-methylimidazole, 2-phenylimidazole, ethyltriphenylphosphonium acetate, or mixtures thereof.

The hardening accelerators of the component (C) in the epoxy resin composition proposed in the present invention can be used singly or in combination as a mixture containing two or more different hardening accelerators. The hardening accelerator is added in an amount of 0.01 to 5%, and more preferably 0.01 to 2%, by weight based on the total weight of the composition. Reduced reaction efficiency will be resulted due to a low reaction rate if the added hardening accelerator is in an amount of less than 0.01% by weight based on the total weight of the composition. Formation of side products, electrical properties, moisture resistance and water absorption will be adversely influenced if the added hardening accelerator is in an amount of more than 5% by weight based on the total weight of the composition. Therefore, an appropriate amount of the hardening accelerator is added to preferably provide a gelation time of 20 to 150 seconds at 150° C. and a viscosity of 20 to 1000 poise at 150° C.

Moreover, in order to reduce stress on the products, an elastic material can be added into the resin composition proposed in the present invention or the elastic material can be pre-reacted with the resins. Examples of the elastic materials include polybutadiene, butadiene-propylene copolymer, silicone rubber, silicone oil, and the like.

Further, additives such as an antioxidant (phenols, amines, organic phosphides, and the like), a modifier (diols, silicones, alcohols, and the like), a defoamer, a discoloring inhibitor, a dye, a UV absorbent, and the like can be optionally added into the epoxy resin composition proposed in the present invention to prevent the optical properties of the composition from deteriorating.

The semiconductor elements packaged with the epoxy resin are fabricated by molding the epoxy resin composition proposed in the present invention using any prior-art molding techniques such as transfer molding, press molding and injection molding prior to curing of the composition.

In reference to the packaging materials for the photosemiconductor elements, the epoxy resin composition proposed in the present invention provides excellent properties such as heat resistance, light transmittance, moisture absorption and adhesiveness of the products, such that the quality of the products is maintained as well as the yield of the products is improved.

The following embodiment only serves to provide further description for the present invention with no intent to limit the scope of the invention.

### EXAMPLES

Each component used in the Examples and Comparative Examples is illustrated in detail as following:

Epoxy resin 1 represents bisphenol A polyglycidyl ether which is sold under trade name BE-501 and manufactured by Chang Chun Plastics Co., Ltd., Taiwan. The epoxy equivalent weight thereof is about 500 g/eq.

Epoxy resin 2 represents cresol-aldehyde condensate polyglycidyl ether which is sold under trade name CNF 200 ELB and manufactured by Chang Chun Plastics Co., Ltd., Taiwan. The epoxy equivalent weight thereof is in the range of 200 to 220 g/eq and the hydrolytic chlorine content is below 200 ppm.

Epoxy resin 3 represents triglycidyl ether of isocyanurate which is sold under trade name TEPIC and manufactured by Nissan Chemical Industries, Ltd., Japan. The epoxy equivalent weight thereof is about 100 g/eq.

Hardener A represents hexahydrophthalic anhydride which is sold under trade name HHPA and manufactured by New Japan Chemical Co., Ltd., Japan. The active hydrogen equivalent weight in the hardener is about 154 g/eq.

Hardener B represents a phenol-aldehyde resin which is sold under trade name PF-5100 and manufactured by Change Chun Plastics Co., Ltd., Taiwan. The active hydrogen equivalent weight in the hardener is about 105 g/eq.

Hardening accelerator A represents triphenylphosphine.

Hardening accelerator B represents 2-methylimidazole.

Antioxidant represents 2,6-dibutyl-p-cresol.

### Synthesis Example 1

740 g of phenol and 98.2 g of cyclohexanone are heated and stirred at 300 rpm to dissolve in a 1 L four-neck glass reaction vessel equipped with a condenser, a stirrer and a temperature-controlling apparatus. As the temperature reaches 70° C., 35 ml of HCl is slowly added in dropwise and stirred at a constant temperature of 70° C. for 6 hours to produce a white solid precipitate. After the reaction is completed, the precipitate is cooled down to room temperature prior to filtration. Then, the precipitate is washed with dichloromethane to remove excess phenol prior to drying to obtain 320 g of bisphenol compounds. Afterwards, the obtained 320 g of bisphenol compounds and 925 g of epichlorohydrin are heated and stirred in a glass autoclave. As the temperature reaches 55° C., the autoclave is evacuated. Then, 153.5 g of 49.5% aqueous sodium hydroxide solution is added into the autoclave and incubated for 5 hours. The above reaction composition is heated under vacuum to recover the unreacted epichlorohydrin until the temperature reaches 155° C. Then, the pressure of the autoclave is released before an organic solvent and water are added. After discharging the water, the organic solvent is recovered from resin solutions to obtain 410 g of epoxy resins represented by Formula (I) (wherein m, n=0; x=0.1). The epoxy equivalent of the epoxy resin obtained from Synthesis 1 is found to be 200 g/eq after analysis.

### Examples 1 to 6 and Comparative Examples 1 to 3

The listed components in amounts (wt %) shown in Table 1 are completely mixed using a stirrer prior to rolling using a biaxial roller at 80° C. After cooling down, the above mixture is pulverized to obtain the epoxy resin composition for semiconductor packages.

TABLE 1

| | | | | | | | Comparative | Comparative | Comparative |
|---|---|---|---|---|---|---|---|---|---|
| | Example 1 | Example 2 | Example 3 | Example 4 | Example 5 | Example 6 | Example 1 | Example 2 | Example 3 |
| Epoxy resin | 30.0 | 30.0 | 30.0 | 30.0 | 30.0 | 40.0 | | 5.00 | 50.00 |
| (Synthesis | | | | | | | | | |
| Example 1) | | | | | | | | | |
| Epoxy resin 1 | 35.00 | 10.00 | | 20.00 | 15.00 | | 45.00 | 40.00 | |
| Epoxy resin 2 | | | 26.40 | | | | | | |
| Epoxy resin 3 | | 15.00 | | 15.00 | 15.00 | 14.00 | 15.00 | 14.00 | 5.00 |
| Hardener A | 34.40 | 44.60 | 43.00 | | 25.00 | 45.40 | 39.40 | 40.40 | 44.40 |
| Hardener B | | | | 34.60 | 14.50 | | | | |
| Hardening | 0.30 | | 0.30 | | 0.10 | 0.30 | 0.30 | 0.30 | 0.30 |
| accelerator A | | | | | | | | | |
| Hardening | | 0.10 | | 0.10 | 0.10 | | | | |
| accelerator B | | | | | | | | | |
| Antioxidant | 0.30 | 0.30 | 0.30 | 0.30 | 0.30 | 0.30 | 0.30 | 0.30 | 0.30 |
| Total | 100.00 | 100.00 | 100.00 | 100.00 | 100.00 | 100.00 | 100.00 | 100.00 | 100.00 |

The compositions obtained using the processes summarized in the above Examples and Comparative Examples were fabricated into test samples by a transfer molding method. Each test sample was cured in an oven at 150° C. for 4 hours. The properties of each test sample were determined by the following analysis methods, and the results are shown in Table 2.

The epoxy equivalent weight (EEW), spiral flow, gelation time, light transmittance, moisture absorption and reflow heat resistance herein were tested using the following methods:

(1) Epoxy equivalent weight: The epoxy resin was dissolved in a mixed solvent (chlorobenzene: chloroform=1:1) and then the mixture was titrated using HBr/glacial acetic acid. The EEW was determined by the method of ASTM D1652 and the indicator used was crystal violet.

(2) Spiral flow: The spiral flow was determined by the method of EMMI-1-66 under the condition of 70 kg/cm² at 150° C.

(3) Gelation time: The gelation time was measured by placing 0.5 g of blend respectively obtained from the Examples and the Comparative Examples on the cavity on the hot plate at 150° C.

(4) Light transmittance: The light transmittance of a test piece with a length of 30 mm, a width of 10 mm and a thickness of 1 mm was measured under a wavelength of 400 nm using a UV-1601 spectrometer manufactured by Shimadzu.

(5) Moisture absorption: The degree of moisture absorption was measured by steaming a round test piece with a diameter of 25 mm and a thickness of 5 mm over boiling water at 100° C. for 1 hour. The moisture absorption was expressed by the percentage of weight increased due to water absorption.

(6) Reflow heat resistance: 20 pieces of test samples obtained from each Example and Comparative Example were subjected for packaging at 150° C. under a specification of 18 L-PDIP, and then molded and hardened at 150° C. for 4 mins. Each package was inspected for any presence of cracks after being treated under a 85° C./85% RH condition for 48 hours and heated in a solder oven for 10 seconds for three times.

TABLE 2

| | | | | | | | Comparative | Comparative | Comparative |
|---|---|---|---|---|---|---|---|---|---|
| | Example 1 | Example 2 | Example 3 | Example 4 | Example 5 | Example 6 | Example 1 | Example 2 | Example 3 |
| Spiral flow | 110 | 115 | 110 | 105 | 105 | 90 | 120 | 120 | 75 |
| (cm) | | | | | | | | | |
| Gelation time | 43 | 40 | 40 | 40 | 42 | 41 | 40 | 40 | 42 |
| (sec) | | | | | | | | | |
| Light | 90 | 92 | 90 | 85 | 86 | 88 | 92 | 92 | 80 |
| transmittance | | | | | | | | | |
| (% T) | | | | | | | | | |
| Moisture | 0.45 | 0.45 | 0.45 | 0.45 | 0.40 | 0.45 | 0.60 | 0.55 | 0.40 |
| absorption (%) | | | | | | | | | |
| Reflow heat | 0/20 | 0/20 | 0/20 | 0/20 | 0/20 | 0/20 | 4/20 | 2/20 | 0/20 |
| resistance | | | | | | | | | |
| (defective | | | | | | | | | |
| yield) | | | | | | | | | |

As shown in Table 2, if the epoxy resin composition contains an appropriate amount of the epoxy resin represented by Formula (I), the epoxy resin composition will have an excellent balance of properties such as spiral flow, light transmittance, moisture absorption and reflow heat resistance.

Referring to Comparative Example 1, as the epoxy resin composition was formed without any epoxy resin represented by Formula (I), the reflow heat resistance of the products is obviously deteriorated. Furthermore, referring to Comparative Example 2, when the epoxy resin composition cantinas the epoxy resin represented by Formula (I) in an amount of less than 10% by weight based on the total amount of the epoxy resins (i.e. 5% by weight based on the total weight of the composition), the reflow heat resistance of the products is also deteriorated and the moisture absorption exceeds 0.5%. Moreover, referring to Comparative Example 3, when the epoxy resin composition contains the epoxy resin represented by Formula (I) in an amount of more than 90% by weight based on the total amount of the epoxy resins (i.e. 50% by weight based on the total weight of the composition), the light transmittance of the products therefrom is less than 85% T, which is not suitable to be applied in the photosemiconductor fabrication.

What is claimed is:

1. An epoxy resin composition for photosemiconductor packages, comprising:
(A) at least two kinds of epoxy resins, wherein the epoxy resin represented by Formula (I) is in an amount of 10 to 90% by weight based on the total amount of the epoxy resins;
(B) a hardener; and
(C) a hardening accelerator, 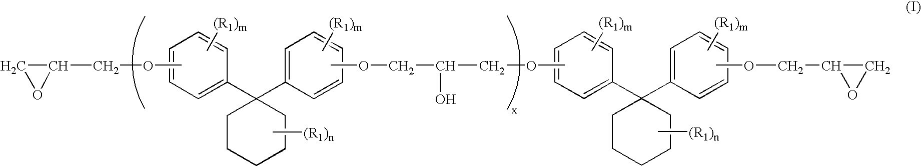
wherein R₁ is a group independently selected from the group consisting of C₁₋₈ alkyls, C₁₋₈ alkoxys, C₃₋₈ cycloalkyls and halogens; m is an integer from 0 to 4; n is an integer from 0 to 5; and x is a number from 0 to 6.

2. The composition of claim 1, wherein the epoxy resin represented by Formula (I) is in an amount of 15 to 85% by weight based on the total amount of the epoxy resins.

3. The composition of claim 2, wherein the epoxy resin represented by Formula (I) is in an amount of 20 to 80% by weight based on the total amount of the epoxy resins.

4. The composition of claim 1, wherein, apart from the epoxy resin represented by Formula (I), another epoxy resin of the component (A) is an epoxy resin produced from monomers selected from the group consisting of bisphenol glycidyl ethers, biphenyol glycidyl ethers, benzenediol glycidyl ethers, nitrogen-containing hetero-ring glycidyl ethers, dihydroxynaphthalene glycidyl ethers, phenolic polyglycidyl ethers, polyhydric phenol polyglycidyl ethers, and mixtures thereof.

5. The composition of claim 4, wherein the bisphenol glycidyl ether is a bisphenol A glycidyl ether.

6. The composition of claim 4, wherein the nitrogen-containing hetero-ring glycidyl ether is a triglycidyl ether of isocyanurate.

7. The composition of claim 1, wherein the hardener of the component (B) is one resin produced from monomers selected from the group consisting of amine compounds, polycarboxylic acids or anhydride thereof compounds, benzenediol compounds, bisphenol resins, polyhydric phenol resins, phenol-aldehyde condensates, and mixtures thereof.

8. The composition of claim 1, wherein the hardener of the component (B) is added in an amount such that an active hydrogen equivalent weight in the hardener is 0.7 to 1.3 times of an epoxy equivalent weight in the epoxy resins of the component (A).

9. The composition of claim 1, wherein the hardener of component (B) is added in an amount of 5 to 50% by weight based on the total weight of the composition.

10. The composition of claim 1, wherein the hardening accelerator of the component C is a compound selected from the group consisting of tertiary amines, tertiary phosphines, quaternary ammonium salts, quaternary phosphonium salts, boron trifluoride complex salts, lithium-containing compounds, imidazole compounds and the mixtures thereof.

11. The composition of claim 1, wherein the hardening accelerator of the component (C) is added in an amount of 0.01 to 5% by weight based on the total weight of the composition.

12. The composition of claim 1, further comprising additives selected from the group consisting of an antioxidant, a modifier, a defoamer, a discoloring inhibitor, a dye and a UV absorbent.

13. The composition of claim 1, wherein a gelation time of the composition is from 20 to 150 seconds at 150° C.

14. The composition of claim 1, wherein a viscosity of the composition is from 20 to 1000 poise at 150° C.

15. The composition of claim 1, which is applied in the photosemiconductor packages.

16. The composition of claim 1, which serves to fabricate a composite material, a powdered dope and a substrate for optical applications.
